(19) United States
(12) Patent Application Publication
(10) Pub. No.: US 2024/0193246 A1
(43) Pub. Date: Jun. 13, 2024

(54) MODIFIED SECURE BOOT TECHNIQUE USING PRE-LOADED EXPECTED TAG IMAGE

(71) Applicant: QUALCOMM Incorporated, San Diego, CA (US)

(72) Inventors: Aneesh BANSAL, San Diego, CA (US); Priyanka DOSI, San Diego, CA (US); Ghanashyam PRABHU, San Diego, CA (US)

(21) Appl. No.: 18/064,901

(22) Filed: Dec. 12, 2022

(51) Int. Cl. G06F 21/36; G06F 21/57

(52) U.S. Cl. CPC G06F 21/36; G06F 21/575; G06F 2221/033

(57) ABSTRACT

Systems and techniques are provided for image authentication for secure boot. For example, a process for image authentication for secure boot can include: obtaining an expected tag image comprising an expected tag corresponding to an image to be loaded into memory; loading the expected tag into a first memory region corresponding to a hardware memory authenticator; loading, by the memory controller, the image into a second memory region; providing an authentication indication to the hardware memory authenticator, wherein the authentication indication triggers the hardware memory authenticator to authenticate the image; reading a portion of the image from the second memory region; generating, at the hardware memory authenticator, an authentication tag corresponding to the portion of the image; and performing a comparison of the authentication tag and the expected tag to obtain an authentication result, wherein, the authentication result is a successful match, and the portion of the image is authenticated.

### FIELD

The present disclosure generally relates to a modified technique for a secure boot process. Aspects of the present disclosure relate to using an expected tag image in conjunction with a hardware memory authenticator to authenticate software images for secure use on computing devices.

### BACKGROUND

Devices that include embedded systems (e.g., a System on Chip (SoC)) often implement some form of a secure boot process. A secure boot process may provide authentication (e.g., signature verification, integrity checking, etc.) of one or more software images at different stages, such as initial boot of the device, reboot of the device, returning a device from hibernation, when restarting device sub-systems, etc. However, separately authenticating any number of software images during a secure boot process using cryptographic software may adversely impact boot performance in terms of time (e.g., boot time) and/or power consumption.

### SUMMARY

Systems and techniques are described herein for a modified secure boot process that includes using an expected tag image to authenticate software images being used on a computing device. According to some aspects of the present disclosure, the systems and techniques can use a previously generated and/or authenticated expected tag image for authenticating additional software images loaded during a secure boot process.

According to at least one example, a process for identity impersonation in access control systems is provided. The process includes: obtaining an expected tag image comprising an expected tag corresponding to an image to be loaded into memory; loading, by a memory controller, the expected tag into a first memory region corresponding to a hardware memory authenticator; loading, by the memory controller, the image into a second memory region; providing an authentication indication to the hardware memory authenticator, wherein the authentication indication triggers the hardware memory authenticator to authenticate the image; reading a portion of the image from the second memory region; generating, at the hardware memory authenticator, an authentication tag corresponding to the portion of the image; and performing a comparison of the authentication tag and the expected tag to obtain an authentication result, wherein, the authentication result is a successful match, and the portion of the image is authenticated.

In another illustrative example, an apparatus for image authentication for secure boot is provided. The apparatus may include at least one memory; and at least one processor coupled to the at least one memory and configured to: obtain an expected tag image comprising an expected tag corresponding to an image to be loaded into memory; load, by a memory controller, the expected tag into a first memory region corresponding to a hardware memory authenticator; load, by the memory controller, the image into a second memory region; provide an authentication indication to the hardware memory authenticator, wherein the authentication indication triggers the hardware memory authenticator to authenticate the image; read a portion of the image from the second memory region; generate, at the hardware memory authenticator, an authentication tag corresponding to the portion of the image; and perform a comparison of the authentication tag and the expected tag to obtain an authentication result, wherein, the authentication result is a successful match, and the portion of the image is authenticated.

In another illustrative example, a non-transitory computer readable medium is provided that has stored thereon instructions that, when executed by one or more processors, cause the one or more processors to: obtain an expected tag image comprising an expected tag corresponding to an image to be loaded into memory; load, by a memory controller, the expected tag into a first memory region corresponding to a hardware memory authenticator; load, by the memory controller, the image into a second memory region; provide an authentication indication to the hardware memory authenticator, wherein the authentication indication triggers the hardware memory authenticator to authenticate the image; read a portion of the image from the second memory region; generate, at the hardware memory authenticator, an authentication tag corresponding to the portion of the image; and perform a comparison of the authentication tag and the expected tag to obtain an authentication result, wherein, the authentication result is a successful match, and the portion of the image is authenticated.

In another illustrative example, an apparatus for image authentication for secure boot is provided. The apparatus may include: means for obtaining an expected tag image comprising an expected tag corresponding to an image to be loaded into memory; means for loading, by a memory controller, the expected tag into a first memory region corresponding to a hardware memory authenticator; means for loading, by the memory controller, the image into a second memory region; means for providing an authentication indication to the hardware memory authenticator, wherein the authentication indication triggers the hardware memory authenticator to authenticate the image; means for reading a portion of the image from the second memory region; means for generating, at the hardware memory authenticator, an authentication tag corresponding to the portion of the image; and means for performing a comparison of the authentication tag and the expected tag to obtain an authentication result, wherein, the authentication result is a successful match, and the portion of the image is authenticated.

In some aspects, one or more of the apparatuses described herein is, is part of, and/or includes a mobile or wireless communication device (e.g., a mobile telephone or other mobile device), an extended reality (XR) device or system (e.g., a virtual reality (VR) device, an augmented reality (AR) device, or a mixed reality (MR) device), a wearable device (e.g., a network-connected watch or other wearable device), a vehicle or a computing device or component of a vehicle, a camera, a personal computer, a laptop computer, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), a system-on-a-chip (SoC), any combination thereof, and/or other type of device. In some aspects, the apparatus(es) include(s) a camera or multiple cameras for capturing one or more images. In some aspects, the apparatus(es) include(s) a display for displaying one or more images, notifications, and/or other displayable data. In some aspects, the apparatus(es) include(s) can include one or more sensors (e.g., one or more RF sensors), such as one or more gyroscopes, one or more gyrometers, one or more accelerometers, any combination thereof, and/or other sensor(s).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating certain components of a computing device, in accordance with some examples;

FIG. 2 is a block diagram illustrating a hardware identity impersonator, in accordance with some examples;

FIG. 3 is a block diagram illustrating an environment in which a technique for a modified secure boot process is implemented, in accordance with some examples;

FIG. 4 is a block diagram illustrating an environment in which a technique for a modified secure boot process is implemented, in accordance with some examples;

FIG. 5 is a block diagram illustrating an environment in which a technique for a modified secure boot process is implemented, in accordance with some examples;

FIG. 6 is a flow diagram illustrating an example process for a modified secure boot technique, in accordance with some examples;

FIG. 7 is a diagram illustrating an example of a computing system for implementing certain aspects described herein.

### DETAILED DESCRIPTION

Certain aspects and examples of this disclosure are provided below. Some of these aspects and examples may be applied independently and some of them may be applied in combination, as would be apparent to those of skill in the art. In the following description, for the purposes of explanation, specific details are set forth in order to provide a thorough understanding of examples of the application. However, it will be apparent that various examples may be practiced without these specific details. The figures and description are not intended to be restrictive. Additionally, certain details known to those of ordinary skill in the art may be omitted to avoid obscuring the description.

In the below description of the figures, any component described with regard to a figure, in various examples described herein, may be equivalent to one or more like-named (or numbered) components described with regard to any other figure. For brevity, descriptions of these components may not be wholly repeated with regard to each figure. Thus, each and every example of the components of each figure is incorporated by reference and assumed to be optionally present within every other figure having one or more like-named components. Additionally, in accordance with various examples described herein, any description of the components of a figure is to be interpreted as an optional example, which may be implemented in addition to, in conjunction with, or in place of the examples described with regard to a corresponding like-named component in any other figure.

The ensuing description provides illustrative examples only, and is not intended to limit the scope, applicability, or configuration of the disclosure. Rather, the ensuing description of the illustrative examples will provide those skilled in the art with an enabling description for implementing an exemplary example. It should be understood that various changes may be made in the function and arrangement of elements without departing from the spirit and scope of the application as set forth in the appended claims.

As used herein, the phrase operatively connected, or operative connection (or any variation thereof), means that there exists between elements/components/devices, etc. a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection. Additionally, operatively connected devices and/or components may exchange things other than information, such as, for example, electrical current, radio frequency signals, etc.

Systems, apparatuses, processes (also referred to as methods), and computer-readable media (collectively referred to as “systems and techniques”) are described herein for providing an improved secure boot process, which may decrease boot time, decrease power consumption, among providing other advantages. When implementing a secure boot process, a device may load software images (which may be referred to herein as images) into device memory. The software images may correspond to any portion and/or subsystem of the device, such as, for example, an operating system, modem sub-systems, a hypervisor, a digital signal processor (DSP) sub-system, etc.

A secure boot process may include, on a per software image basis, obtaining metadata corresponding to the image, verifying a signature corresponding to the image, loading the image into memory from storage, obtaining segments of the image from the memory, hashing the segments, comparing the hash against an expected hash (e.g., obtained from a hash segment metadata of the image), and authenticating the image only when all of the hashes successfully match. An image may be considered loaded and ready to use when the authentication is successful. The hashing of the segments and hash comparison is often performed by a cryptographic software block. Thus, to successfully complete a secure boot of a device (or any aspect thereof), each image to be loaded (e.g., ten images) may be subjected to a process wherein cryptographic software is used to validate the signature of each image, and further to execute a hashing algorithm for each segment of each image in order to perform the authentication hash comparison. The hashing of the image segments may become an expensive operation in time and power consumption proportional to the size of the image. As such, the above-described secure boot process may fail to meet boot time requirements in certain scenarios, such as, for example, when faster boot times and/or lower boot power consumption is required (e.g., automotive computing devices, Internet of Things (IoT) devices, etc.).

Additionally, memory controllers may include hardware memory authenticators for implementing runtime memory integrity checking. Such hardware memory authenticators may be configured to calculate authentication tags for images, or portions thereof, prior to or as the images are being loaded to memory (e.g., during a secure boot process, during a sub-system restart, when returning the device from hibernation, etc.). When the images, or portions thereof, are to be read during runtime, the hardware memory authenticator may be configured to obtain the data to be read, calculate a tag for the data, and compare it with the previously calculated tag for the data. If the comparison yields a successful match, the integrity of the data is verified. If not, then the integrity check fails for the runtime data (e.g., a detection of corrupted data has occurred), and, for example, the corrupted data may not be made available for processing (e.g., by or more processors of a computing device).

In order to improve a secure boot process (e.g., improving boot times and power consumption), the systems and techniques provided herein can modify the secure boot process by using an expected tag image. A tag, as used herein, refers to an authentication tag. An authentication tag (e.g., a message authentication code (MAC)) may be any information item that allows for the authentication of data of any size or type. As an example, software images (e.g., data), or segments therein, to be loaded during a secure boot process may be input to a hashing algorithm to obtain an output, or hash, of the segment, with each hash serving as a tag for the segment. An expected tag may be a tag that is calculated prior to a secure boot process. For example, expected tags may be obtained separate from the device on which a secure boot is to be performed (e.g., obtained ‘offline’). In some examples, the collection of expected tags for all or any portion of the images (e.g., software images) to be loaded during a secure boot process may be collected and included in a separate image, referred to herein as an expected tag image. The expected tag image, like other images, may itself be signed and authenticated prior top use, as is discussed further below. Additionally, in some examples, the expected tag image may be authenticated, and protected from modification to be used as a root of trust, with the authentication being performed using techniques related to hashing and signing.

The expected tag image may then be loaded using a secure boot process such as the one described above (e.g., using hashing and signature verification techniques to authenticate the expected tag image). For example, at or near the beginning of a secure boot process, prior to loading at least a portion of the other images to be loaded, the expected tag image may be obtained (e.g., from flash storage by a storage controller), and provided to a memory controller. The memory controller may then obtain metadata from the expected tag image and use the metadata and cryptographic software to perform a signature validation for the image, as well as hash the expected tag image, and/or portions thereof, to perform hash comparisons (e.g., also using the metadata for the expected tag image). Once the signature verification and the hash comparisons have been successfully performed, the expected tag image may be considered authenticated. As such, the expected tags of the expected tag image may be loaded into a memory region (e.g., an expected tag region) for later use by a hardware memory authenticator of the memory controller, where the memory region corresponds to the hardware memory authenticator and is, at least temporarily, accessible by the hardware memory authenticator. In some examples, the memory region storing expected tags may be locked, and accessible only by the hardware memory authenticator for at least the secure boot process, and the hardware memory authenticator may be configured to access the memory region to obtain expected tags when authenticating software images. The hardware memory authenticator may remain inactive (e.g., an active bit for the hardware memory authenticator may be set to zero) during the load of the expected tag image.

The modified secure boot process may then continue to be performed. As the modified secure boot process continues, the hardware memory authenticator may remain off (e.g., disactivated). For example, an indicator bit for the hardware memory authenticator may remain set to zero. The images to be loaded during the secure boot process may then be loaded into memory without being subjected to the signature verification, hash comparison, and/or authentication process used in prior secure boot processes. The hardware memory authenticator may be configured to be disactivated at the start of a secure boot process (e.g., during boot, reboot, sub-system reboot, etc.) In some examples, having the hardware memory authenticator disactivated causes the hardware memory authenticator to not perform authentication operations, which may improve performance of the initial portion of a secure boot process.

Next, the hardware memory authenticator may be provided an indication (e.g., an active indicator bit may be set to a value such as zero or one) to begin performing authentication of the images already in memory (e.g., memory regions in which an image has been loaded, which may be similar to requesting the hardware to perform a dummy read of the region) in parallel with other operations being performed (e.g., loading additional images, performing operations using loaded and previously authenticated images, etc.). In response to the indication, the hardware memory authenticator may obtain the images, or portions thereof, from the memory, calculate the tags, and compare the tags with the previously loaded expected tags in order to authenticate the images. In some examples, signature verification may be performed on the tags. In some examples, once a software image has been authenticated using the above-described process, the software image may be executed on the computing device.

Using the above-described modified secure boot process, boot times and power consumption may be improved (e.g., boot times may be reduced and/or power consumption may be reduced). As an example, the signature verifications for every image to be loaded may no longer be performed using cryptographic software, and hashes may also not be performed using cryptographic software (as they may instead be performed using the hardware memory authenticator). Additionally, as another example, performing authentication by checking tags calculated by the hardware memory authenticator against previously loaded and trusted expected tags in parallel with other operations being performed may further improve boot time.

Additionally or alternatively, in some examples, memory may be conserved and made available for use after the modified secure boot process described above completes by deleting (e.g., discarding) all or any portion of the expected tags from memory. As an example, in some scenarios, one or more images loaded as part of the modified secure boot process may not require being re-used unless the device is rebooted (which would delete the expected tags anyway), such as the operating system, hypervisor, etc. If there are no images that might be re-used during runtime, then the expected tags may be deleted from memory, thereby making that memory available to the device for other purposes. However, if there are images that may be restarted without a full reboot (e.g., restart of a modem, other peripheral device, etc.), the expected tags may instead be maintained in memory, and an in-order processing of such tags may be maintained.

In one alternate or additional example, the modified boot process may not use an expected tag image as described above. Instead, on a first secure boot process (e.g., during a first powering or power cycling of the device), the memory controller and/or hardware memory authenticator may calculate tags for one or more images, and build an expected tag repository in a region of memory to be used later, as in the above-described modified secure boot process. As an example, the expected tags generated in this alternate manner may be used for restarting sub-systems (e.g., modem sub-systems), and authenticating the image for the restarted sub-system. This alternate technique for generating and using expected tags may be a less impactful change to existing secure boot processes, while still providing an improvement in performance (e.g., time to restart sub-systems).

Examples described herein may address the need to improve device performance by reducing or eliminating time-consuming software operations to be performed during a secure boot process for a computing device.

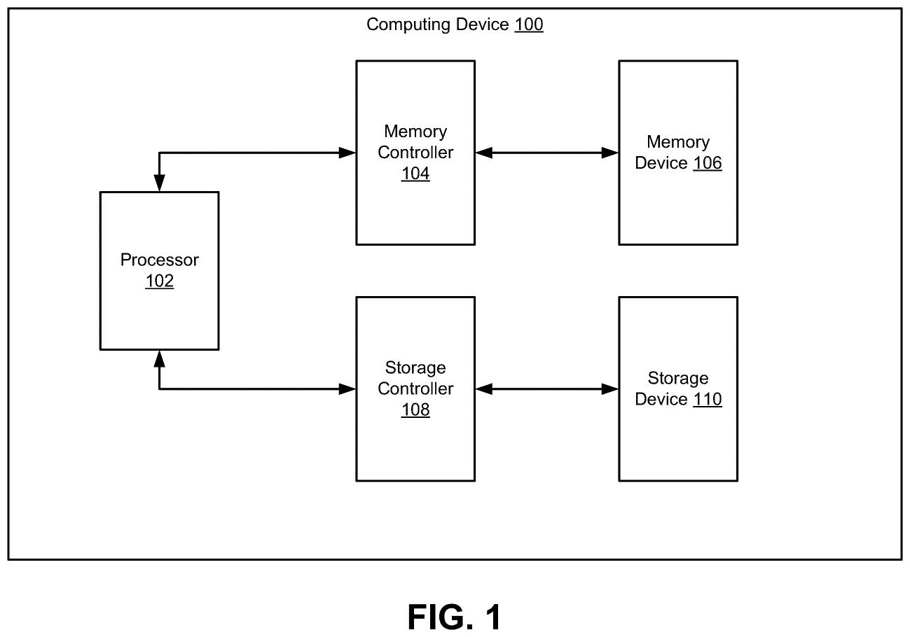

Various aspects of the systems and techniques described herein will be discussed below with respect to the figures. FIG. 1 is a block diagram illustrating an example of a computing device 100. As shown, the computing device 100 includes a processor 102, a memory controller 104, a memory device 106, a storage controller 108, and a storage device 110. Each of these components is described below.

The computing device 100 is any device, portion of a device, or any set of devices capable of electronically processing instructions and may include, but is not limited to, any of the following: one or more processors (e.g. components that include integrated circuitry, memory, input and output device(s) (not shown), non-volatile storage hardware (not shown), one or more physical interfaces (not shown), any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IoT) device, a server (e.g., a blade-server in a blade-server chassis, a rack server in a rack, etc.), a desktop computer, a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality, virtual reality, etc.), any device that includes one or more SoCs, and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

In some examples, the computing device 100 includes the processor 102. In some examples, the processor 102 is any component that includes circuitry for executing instructions (e.g., of a computer program). As an example, such circuitry may be integrated circuitry implemented, at least in part, using transistors implementing such components as arithmetic logic units, control units, logic gates, registers, etc. In some examples, the processor may include additional components, such as, for example, cache memory. In some examples, a processor retrieves and decodes instructions, which are then executed. Execution of instructions may include operating on data, which may include reading and/or writing data. In some examples, the instructions and data used by a processor are stored in the memory (e.g., memory device 106) of the computing device 100. A processor may perform various operations for executing software, such as operating systems, applications, etc. The processor 102 may cause data to be written from memory to storage of the computing device 100 and/or cause data to be read from storage via the memory. Examples of processors include, but are not limited to, central processing units (CPUs), graphics processing units (GPUs), neural processing units, tensor processing units, data processing units (DPUs), digital signal processors (DSPs), etc.

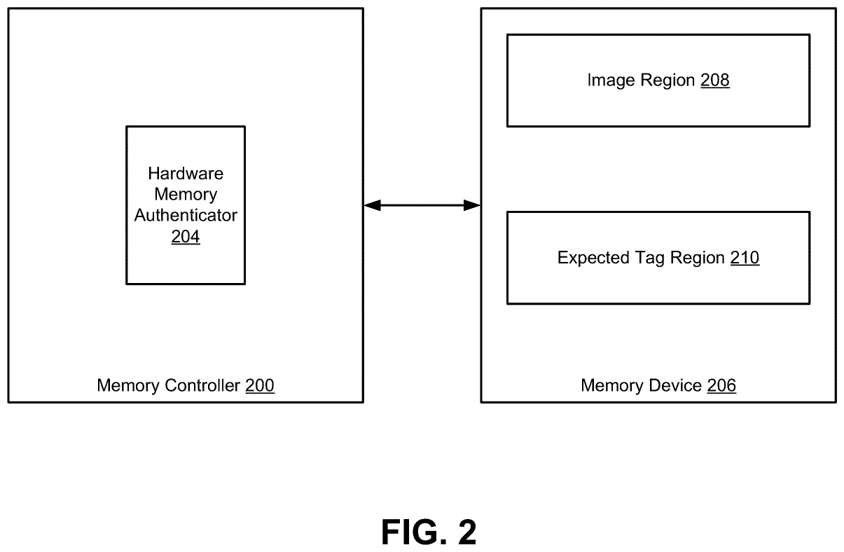

In some examples, the computing device 100 includes a memory controller 104. In some examples, the memory controller 104 is operatively connected to the processor 102. In some examples, the memory controller 104 is any hardware, software, firmware, or any combination thereof that is configured to manage, at least in part, the data being transmitted to and/or from the memory (e.g., memory device 106) of the computing device 100. Although FIG. 1 shows the memory controller 104 as separate from the processor 102, one of ordinary skill in the relevant art will appreciate that all or any portion of the functionality of the memory controller may be incorporated into the processor 102 and/or be implemented separately from the processor 102. Additional aspects of the memory controller 104 are discussed further in the description of FIG. 2, below. Although FIG. 1 shows the computing device 100 having a single memory controller 104, the computing device 100 may have any number of memory controllers without departing from the scope of examples described herein.

In some examples, the computing device 100 includes a memory device 106. In some examples, the memory device 106 is operatively connected to the memory controller 104. The memory device 106 may be any type of computer memory. In some examples, the memory device 106 is a volatile storage device. As an example, the memory device 106 may be random access memory (RAM). In one or more examples, data stored in the memory device 106 is located at memory addresses, and is thus accessible to the processor 102 using the memory addresses. Similarly, the processor 102 may write data to the memory device 106 using the memory addresses. In some examples, interactions between the processor 102 and the memory device 106 may be facilitated, at least in part, using the memory controller 104. The memory device 106 may be used to store any type of data, such as, for example, software images, computer programs, the results of computations, etc. In some examples, the memory device 106 is operatively connected to the processor 102 (e.g., via the memory controller 104) Although FIG. 1 shows the computing device 100 having a single memory device 106, the computing device 100 may have any number of memory devices without departing from the scope of examples described herein.

In some examples, the computing device 100 includes the storage controller 108. In some examples, the storage controller 108 is operatively connected to the processor 102. In some examples, the storage controller 108 is any hardware, software, firmware, or any combination thereof that is configured to manage, at least in part, the access of data stored on any number of storage devices (e.g., the storage device 110). A storage controller (e.g., the storage controller 108) may include and/or be operatively connected to any number of other devices, components, etc. (not shown) for managing the access of data stored on a storage device (e.g., the storage device 110). The storage controller 108 may control access to data stored on any number of storage devices (e.g., the storage device 110) by, for example, providing access (which may be controlled access) to other components of the computing device 100 when reading data from and/or writing data to the storage devices. Although FIG. 1 shows the computing device 100 as including a single storage controller 108, the computing device 100 may include any number of storage controllers without departing from the scope of examples described herein. The storage controller 108 may be configured to implement any number of storage device-related specifications, best-practices, protocols, etc., in order to manage access to storage devices for a given computing device.

In some examples, the computing device 100 includes a storage device 110. In some examples, the storage device 110 is operatively connected to the storage controller 108. In some examples, the storage device 110 is operatively connected to the processor 102 (e.g., via the storage controller 108). The storage device 110 may be used for storing data of any type. Data may be written to and/or read from the storage device 110. As an example, the storage device 110 may store operating system images, software images, application data, etc. The storage device 110 may store any other type of data without departing from the scope of examples described herein. In some examples, the storage device 110 is a flash storage device. In some examples, the storage device 110 includes NAND flash storage. The storage device 110 may use any other type of storage technology without departing from the scope of examples described herein. Although FIG. 1 shows the computing device 100 having a single storage device 110, the computing device 100 may include any number of storage devices without departing from the scope of examples described herein.

In some examples, the computing device 100 includes storage device 110 is a non-volatile storage device. The storage device 110 may, for example, be a persistent memory device. In some examples, the storage device 110 may be computer storage of any type. Examples of type of computer storage include, but are not limited to, hard disk drives, solid state drives, flash storage, tape drives, removable disk drives, Universal Serial Bus (USB) storage devices, secure digital (SD) cards, optical storage devices, read-only memory devices, etc. Although FIG. 1 shows the storage device 110 as part of the computing device 100, the storage device 110 may be separate from and operatively connected to the computing device 100 (e.g., an external drive array, cloud storage, etc.).

While FIG. 1 shows a certain number of components in a particular configuration, one of ordinary skill in the art will appreciate that the computing device 100 may include more components or fewer components, and/or components arranged in any number of alternate configurations without departing from the scope of examples described herein. Additionally, although not shown in FIG. 1, one of ordinary skill in the art will appreciate that the computing device 100 may, when powered on, execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 1.

FIG. 2 is a block diagram of an example portion of a computing device (e.g., the computing device 100 of FIG. 1) that includes a memory controller 200 and a memory device 206. The memory controller 200 may include a hardware memory authenticator 204, and the memory device 206 may include an image region 208 and an expected tag region 210. Each of these components is described below.

In some examples, the memory controller 200 is the same or substantially similar to the memory controller 104 shown in FIG. 1 and described above. As such, the memory controller is configured to control access to one or more memory devices (e.g., memory device 206). In some examples, the memory controller 200 includes the hardware memory authenticator 204. In some examples, the hardware memory authenticator 204 is any hardware, software, firmware, or any combination thereof that is configured to perform various tasks relating to access of a memory device (e.g., the memory device 206).

In some examples, the hardware memory authenticator 204 is configured to perform runtime integrity checking for software being used from a memory device (e.g., the memory device 206). To that end, in some examples, the hardware memory authenticator 204 may be configured to calculate authentication tags for images (e.g., software images), or portions thereof, prior to or as the images are being loaded to memory (e.g., during a secure boot process, during a sub-system restart, when returning the device from hibernation, etc.). When the images, or portions thereof, are to be read during runtime, the hardware memory authenticator may be configured to obtain the data to be read, calculate a tag for the data, and compare it with the previously calculated tag for the data. If the comparison yields a successful match, the integrity of the data is verified. If not, then the integrity check fails for the runtime data (e.g., a detection of corrupted data has occurred), and, for example, the corrupted data is not made available for processing.

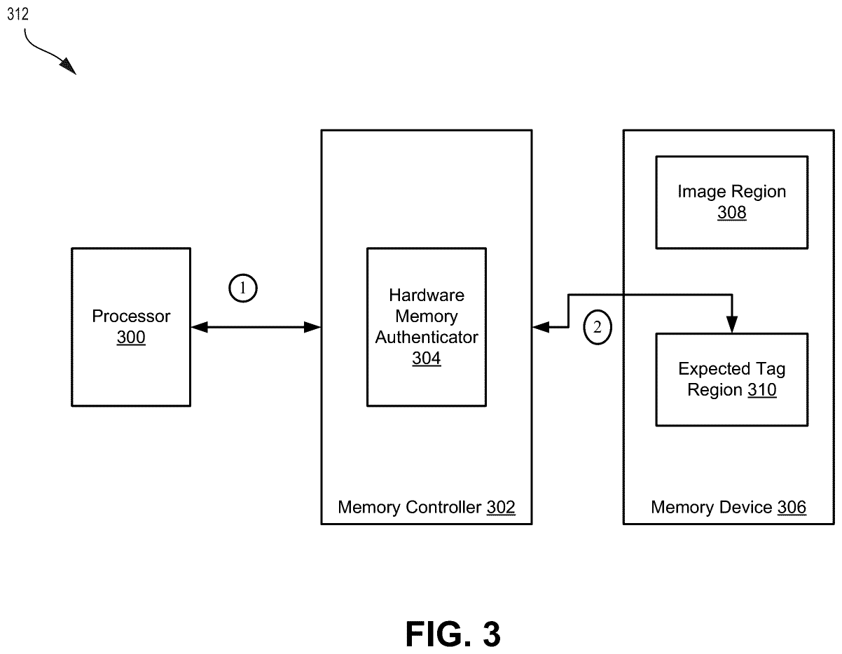

In some examples, the hardware memory authenticator 204 is configured to perform certain operations in response to an authentication indication. As an example, an authentication indication may be a certain configuration bit (e.g., a one or a zero), which determines whether the hardware memory authenticator 204 is to perform authentication of certain data. In some examples, the hardware memory authenticator 204 may have a configuration bit set to a certain state (e.g., zero) in order to cause the hardware memory authenticator 204 to not perform operations as data is passed through the memory controller 200, and set to a different state (e.g., one) in order to cause the hardware memory authenticator 204 to perform certain operations in order to authenticate data that has passed through the memory controller 200. Operations performed by the hardware memory authenticator 204 are discussed further in the description of FIGS. 3-5, below.

In one or more embodiments, the memory device 206 is the same or substantially similar to the memory device 106 shown in FIG. 1 and described above. As such, the memory device 206 may include any number of memory regions. In some examples, a memory region may be any portion of memory, which may or may not include contiguous sections of memory. In some examples, one such region is the image region 208. In some examples, the image region 208 is any region of a memory device configured to store one or more software images, which may be used to control any portion of a computing device (e.g., the computing device 100 of FIG. 1) or otherwise be loaded onto a computing system (e.g., during a secure boot process) so that software included in the image may be executed on the computing device. As such, in some examples, a software image may include application code, one or more executable files, any data files related to the software of the image, etc. The software images (which may be referred to as images) may correspond to any portion and/or subsystem of the device, such as, for example, an operating system, modem sub-systems, a hypervisor, a digital signal processor (DSP) sub-system, etc.

In some examples, the memory device 206 includes an expected tag region 210. In some examples, the expected tag region 210 is a portion of the memory device 206 that is associated with and/or corresponding to the hardware memory authenticator 204. In some examples, the expected tag region 210 is configured to store an expected tag image. A tag, as used herein, refers to an authentication tag. An authentication tag (e.g., a message authentication code (MAC)) may be any information item that allows for the authentication of data of any size or type. As an example, software images (e.g., data), or segments therein, to be loaded during a secure boot process may be input to a hashing algorithm to obtain an output, or hash, of the segment, with each hash serving as a tag for the segment. An expected tag may be a tag that is calculated prior to a secure boot process. For example, expected tags may be obtained separate from the device on which a secure boot is to be performed (e.g., obtained ‘offline’). The collection of expected tags for all or any portion of the images to be loaded during a secure boot process may be included in a separate image, referred to herein as an expected tag image. The expected tag image, like other images, may itself be signed. In some examples, the memory region (e.g., the expected tag region 210) corresponding to the hardware memory authenticator 204 may be locked during at least a secure boot process such that only the hardware memory authenticator may access the memory region.

While FIG. 2 shows a certain number of components in a particular configuration, one of ordinary skill in the art will appreciate that a computing device (e.g., the computing device 100) may include more components or fewer components, and/or components arranged in any number of alternate configurations without departing from the scope of examples described herein. Accordingly, examples disclosed herein should not be limited to the configuration of components shown in FIG. 1.

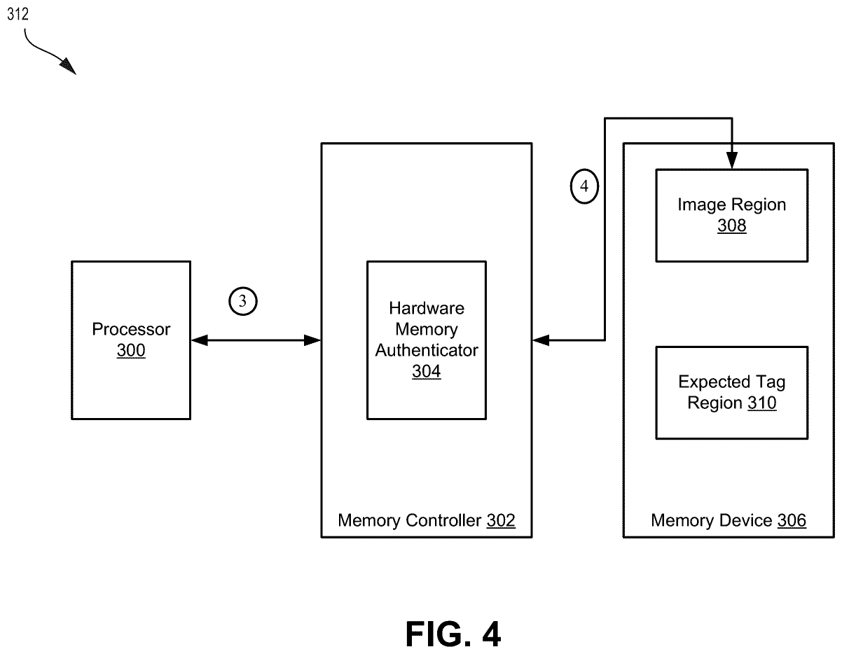

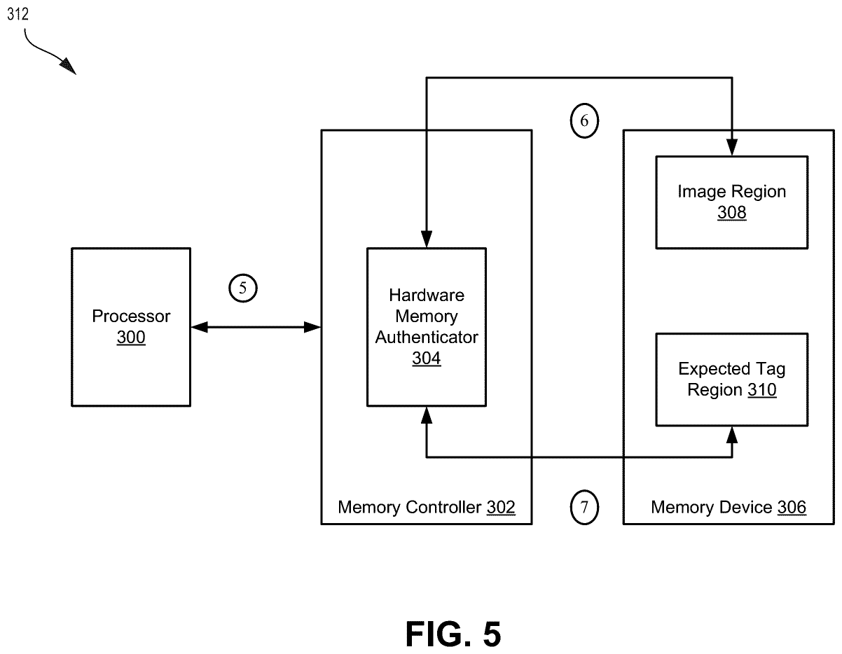

FIG. 3, FIG. 4, and FIG. 5 illustrate an example environment 312 in accordance with one or more examples described herein. The following example is for explanatory purposes only and not intended to limit the scope of examples described herein. Additionally, while the example shows certain aspects of examples described herein, all possible aspects of such examples may not be illustrated in this particular example.

The environment 312 illustrated in FIG. 3 depicts an example scenario in which a computing device implements a modified secure boot process. In such a scenario, a configuration bit for the hardware memory authenticator 304 may be set to a value (e.g., zero), indicating that the hardware memory authenticator 304 is not performing operations to authenticate data being written to the memory device 306 (e.g., it is disactivated). The hardware memory authenticator 304 may be configured to be initially disactivated during a boot and/or reboot of a computing device. In some examples, the hardware memory authenticator 304 may be actively disactivated during a boot and/or reboot. As discussed above in the description of FIG. 1 and FIG. 2, whether the hardware memory authenticator 304 is activated or disactivated may be controlled, at least in part, by a configuration setting (e.g., a configuration bit), which may be set to various values (e.g., zero or one) to control the state of the hardware memory authenticator 304. As such, the state (e.g., activated or disactivated) may be changed by providing an indication that changes the configuration setting. As an example, as described above and below, an authentication indication may be provided to the hardware memory authenticator to transition the relevant configuration bit from one value (e.g., zero) to another value (e.g., one) in order to transition the hardware memory authenticator from a disactivated state to an activated state. In some examples, the configuration bit may be referred to as an authentication indicator, and, for example, may be controlled by the processor 300.

In some examples, such as is shown in FIG. 3, an expected tag image is obtained to be loaded and authenticated. The expected tag image may be a software image that includes authentication tags for any number of software images to be loaded in order to execute various functions of a computing device. The authentication tags may be calculated offline (e.g., on a separate computing device (not shown)) using one or more hashing algorithms, and aggregated into the expected tag image. The expected tag image may be stored, prior to the scenario depicted in FIG. 3, in a storage device (not shown) of the computing device of the environment 312. The expected tag image may be obtained from the storage device and stored, by the memory controller 302, at the request from the processor 300, in the expected tag region 310 of the memory device 306. Prior to being loaded into the expected tag region 310 of the memory device 306, the expected tag image may be authenticated. For example, at or near the beginning of a secure boot process, prior to loading at least a portion of the other images to be loaded, the expected tag image may be obtained (e.g., from flash storage by a storage controller), and provided to the memory controller 302. The memory controller may then obtain metadata from the expected tag image, and use the metadata and cryptographic software to perform a signature validation for the image, as well as hash the expected tag image, and/or portions thereof, to perform hash comparisons (e.g., also using the metadata for the expected tag image). Once the signature verification and the hash comparisons have been successfully performed, the expected tag image may be considered authenticated. As such, the expected tags of the expected tag image may be loaded into a memory region for later use by a hardware memory authenticator of the memory controller. The hardware memory authenticator 304 may remain disactivated (e.g., an configuration bit for the hardware memory authenticator may be set to zero) during the load of the expected tag image. In some examples, the expected tag region 310 of the memory device 306 may be locked after the successful authentication and loading of the expected tag image.

Turning to FIG. 4, the configuration bit serving as the authentication indicator for the hardware memory authenticator 304 remains set to a value (e.g., zero), meaning that the hardware memory authenticator 304 remains disactivated. Continuing the scenario, the processor 300 proceeds to load at least one software image for which an expected tag exists in the expected tag region 310 into the image region 308 of the memory device 306. The software image may be loaded into an image region 308 of the memory device 306 via the memory controller 302 without any signature verification or authentication being performed yet.

Turning to FIG. 5, the processor 300 transitions the configuration bit serving as an authentication indicator for the hardware memory authenticator 304 to a value (e.g., one), indicating that the hardware memory authenticator 304 should authenticate the software image previously loaded into the image region 308. The configuration bit is transitioned by providing an authentication indication to the hardware memory authenticator 304. In response to the change of state of the configuration bit, the hardware memory authenticator 304 obtains at least a portion of the software image from the image region 308, and executes a hashing algorithm to obtain an authentication tag corresponding to the software image portion. Next, the hardware memory authenticator 304 obtains an expected authenticated tag for the software image portion from the expected tag region 310. Next, the hardware memory authenticator 304 performs a comparison of the two authentication tags. If the calculated authentication tag and the expected authentication tag for the software image portion match, the authentication of the software image portion is successful. Any number of software image portions may be subjected to the aforementioned procedure to authenticate the software image as a whole. Once all relevant software image portions are so authenticated, execution of the software image may proceed. In some examples, if any software image portion fails the authentication check, the software image may be considered not authenticated, and the execution of the software image on the computing device may be prevented.

In some examples, the process depicted in FIGS. 3-5 may be repeated for any software images to be used during the operation of a computing device. During any such image authentication, other operations may be performed by the computing device (e.g., loading additional images, performing operations using loaded and authenticated images, etc.). In some examples, after successful authentication of one or more software images, all or any portion of the expected tag region may be deleted (e.g., discarded), thereby releasing the expected tag region 310, or a portion thereof, for use by the computing device for other operations. Additionally or alternatively, all or any portion of the expected tags stored in the expected tag region 310 may be retained for use during the operation of the computing device. As an example, certain sub-systems of the computing device (e.g., a modem subsystem) may require a restart while the remainder of the computing device continues to operate. In such scenarios, the above described process may be repeated using for the software image corresponding to the sub-system using an expected tag from the expected tag region 310.

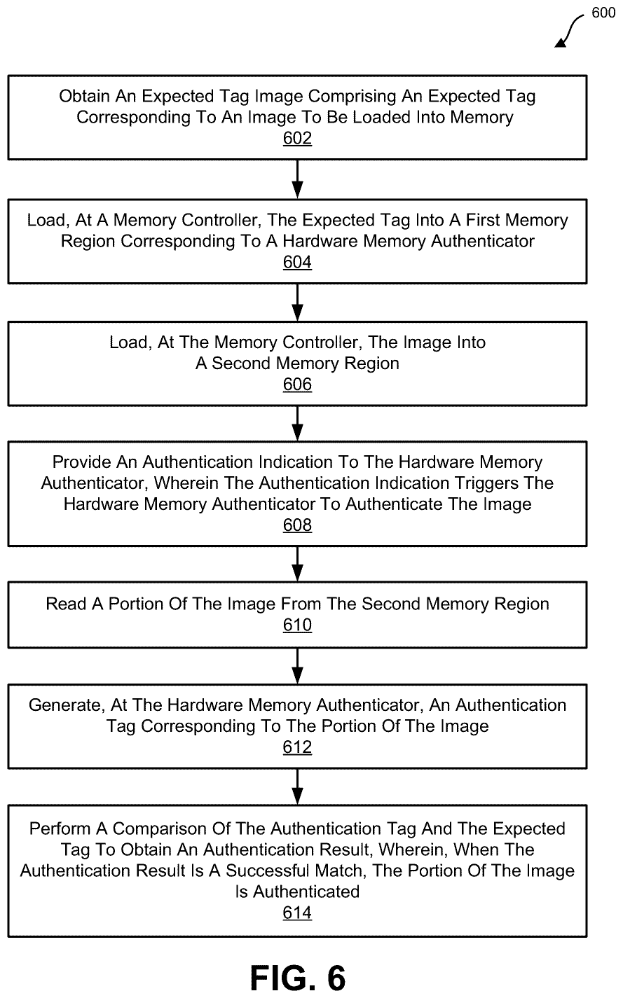

FIG. 6 is a flow diagram illustrating an example of a process 600 for image authentication for secure boot in accordance with examples described herein. The process 600 may be performed, at least in part, for example, by computing device 100 shown in FIG. 1, or any component shown therein (e.g., the processor 102, the memory controller, 104, the storage controller 108, and memory device 106, and/or the storage device 110), the memory controller 200 shown in FIG. 2 and described above, the hardware memory authenticator 204 shown in FIG. 2 and described above, and/or the memory device 206 shown in FIG. 2 and described above.

At block 602, the process 600 includes obtaining an expected tag image comprising an expected tag corresponding to an image to be loaded into memory (e.g., the image region 208 of the memory device 206 of FIG. 2). The expected tag image may be obtained by a processor (e.g., the processor 102 of FIG. 1). The expected tag image may include any number of expected tags corresponding to any number of software images (e.g., images), and/or portions thereof. The expected tag image may be generated offline prior to use for authentication of images (e.g., at a separate computing device). The expected tag image may be a signed image. The expected tag image may be obtained from a storage device (e.g., the storage device 110 of FIG. 1). The expected tag image may be obtained at any time during operation of a computing device, including, but not limited to, during an initial boot, during a boot, during a reboot, during a sub-system reboot, during a return from a device hibernation, etc. In some examples, the expected tag image is subjected to a secure boot procedure to verify a signature for the expected tag image and to authenticate the expected tag image, which occurs prior to loading one or more expected tags of the expected tag image into a memory region (e.g., at block 604).

At block 604, the process 600 includes loading, by a memory controller (e.g., the memory controller 104 of FIG. 1), the expected tag into a first memory region corresponding to a hardware memory authenticator. Any number of expected tags may be loaded into the memory region without departing from the scope of examples described herein. As discussed above, a signature for the expected tag image and/or an authentication of the expected tag image may occur before an expected tag is loaded into the memory region. In some examples, the first memory region is an expected tag region that corresponds to a hardware memory authenticator at least during a secure boot process. As such, in some examples, the first memory region may be a memory region for which the hardware memory authenticator has exclusive access and is configured to access during a secure boot process when authenticating images.

At block 606, the process 600 includes loading, by the memory controller (e.g., the memory controller 104 of FIG. 1), the image into a second memory region. Any number of images may be loaded into the second memory region without departing from the scope of examples described herein. The one or more images loaded into the second memory region may not be subjected to an authentication process as they are being loaded into the second memory region, while the expected tag image is subjected to an authentication process. The second memory region may be a region of a memory device configured to store any number of software images during a secure boot process (e.g., the image region 208 of FIG. 2).

At block 608, the process 600 includes providing an authentication indication to the hardware memory authenticator (e.g., the hardware memory authenticator 204 of FIG. 2), wherein the authentication indication triggers the hardware memory authenticator to authenticate the image. In some examples, an authentication indication is any information that, when provided to a hardware memory authenticator, causes the state of the hardware memory authenticator to transition from a disactivated to an activated state. In some examples, a disactivated state is a state in which a hardware memory authenticator does not perform authentication operations for software images during a secure boot process. In some examples, an activated state is a state in which a hardware memory authenticator performs authentication operations for one or more images (e.g., software images). As an example, a hardware memory authenticator may include and/or be operatively connected to a component for storing a bit, and the state of the bit may control whether a hardware memory authenticator is disactivated or activated. A hardware memory authenticator may be configured to be disactivated at the beginning of a secure boot process (e.g., during boot, reboot, sub-system reboot, returning from system hibernation, etc.). A hardware memory authenticator may be disactivated at any time by changing the state of the configuration bit. As an example, a hardware memory authenticator may be disactivated any time the relevant configuration bit is set to a particular value (e.g., zero). In some examples, as discussed above, providing an authentication indication to a hardware memory authenticator includes changing a configuration bit such that the state of the hardware memory authenticator transitions from disactivated to activated (e.g., by changing the configuration bit from zero to one), which may trigger the hardware memory authenticator to begin authenticating images and/or portions thereof, as part of a secure boot process.

At block 610, the process 600 includes reading a portion of the image from the second memory region (e.g., the image region 208 of FIG. 2). In some examples, the portion of the image is read by a hardware memory authenticator (e.g., the hardware memory authenticator 204 of FIG. 2). A portion of an image may refer to an entire software image, or any sub-portion thereof.

At block 612, the process 600 includes generating, at the hardware memory authenticator (e.g., the hardware memory authenticator 204 of FIG. 2), an authentication tag corresponding to the portion of the image. In some examples, as discussed above in the descriptions of FIGS. 1-5, an authentication tag is any data item that may be used to authenticate all or any portion of an image, such as, for example, a MAC. An authentication tag may be generated using any suitable technique. As an example, an authentication tag may be generated by a hardware memory authenticator by executing a hash function using the portion of the image as input, with the output being the authentication tag.

At block 614, the process 600 includes performing a comparison of the authentication tag and the expected tag to obtain an authentication result, wherein, the authentication result is a successful match, and the portion of the image is authenticated. In some examples, to perform the comparison, the comparison is performed by a hardware memory authenticator (e.g., the hardware memory authenticator 204 of FIG. 2). In some examples, to perform the comparison, the hardware memory authenticator obtains the expected tag corresponding to the portion of the image from the second memory region (e.g., the image region 208 of FIG. 2). In some examples, the comparison results in a successful match of the authentication tag generated by the hardware memory authenticator and the expected tag, indicating that at least the portion of the image is authenticated. An image as a whole may be authenticated when the portions therein are each successfully authenticated. However, in some examples, if a second portion of an image, is not successfully authenticated using the above-described techniques, the authentication of the image may be considered to have failed. In some examples, if an image is successfully authenticated by a hardware memory authenticator, the image may be executed on the computing device. In some examples, if the image is not successfully authenticated, then execution of the image may be not allowed on the computing device.

In some examples, the process 600, or any other process described herein may be performed by a computing device or apparatus, and/or one or more components therein and/or to which the computing device is operatively connected. As an example, the process 600 may be performed wholly or in part by the hardware memory authenticator 204 shown in FIG. 2 and described above.

A hardware memory authenticator may be, include, or be a component of any suitable device, such as a vehicle or a computing device of a vehicle (e.g., a driver monitoring system (DMS) of a vehicle), a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, a smart speaker, a voice assistant device, a SoC, and/or any other device with the resource capabilities to perform the processes described herein, including the process 600, and/or other process described herein. In some cases, a computing device or apparatus (e.g., that includes a hardware identity impersonator) may include various components, such as one or more input devices, one or more output devices, one or more processors, one or more microprocessors, one or more microcomputers, one or more cameras, one or more sensors, and/or other component(s) that are configured to carry out the operations of processes described herein. In some examples, the computing device may include a display, a network interface configured to communicate and/or receive the data, an RF sensing component, any combination thereof, and/or other component(s). The network interface may be configured to communicate and/or receive Internet Protocol (IP) based data or other type of data.

The components of a hardware memory authenticator may be implemented, at least in part, in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented, at least in part, using computer software, firmware, or any combination thereof, to perform the various operations described herein.

The process 600 shown in FIG. 6 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 600, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

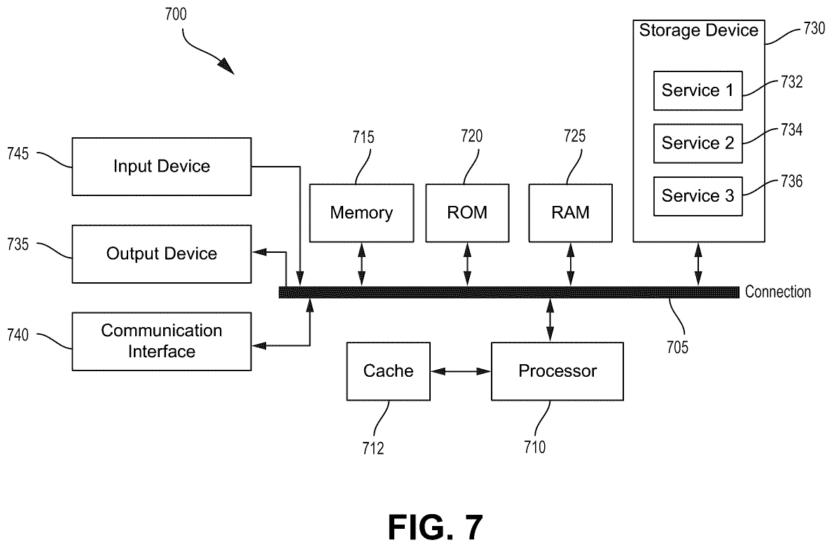

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications using wired and/or wireless transceivers, including those making use of an audio jack/plug, a microphonejack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash storage, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some examples, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples and examples provided herein. However, it will be understood by one of ordinary skill in the art that the examples may be practiced without these specific details. For clarity of explanation, in some instances the present technology may be presented as including individual functional blocks including functional blocks comprising devices, device components, operations, steps, or routines in a method embodied in software, hardware, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smartphones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm operations described in connection with the examples disclosed herein may be implemented as electronic hardware, computer software, firmware, or combinations thereof. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: A method for image authentication for secure boot, the method comprising: obtaining an expected tag image comprising an expected tag corresponding to an image to be loaded into memory; loading, by a memory controller, the expected tag into a first memory region corresponding to a hardware memory authenticator; loading, by the memory controller, the image into a second memory region; providing an authentication indication to the hardware memory authenticator, wherein the authentication indication triggers the hardware memory authenticator to authenticate the image; reading a portion of the image from the second memory region; generating, at the hardware memory authenticator, an authentication tag corresponding to the portion of the image; and performing a comparison of the authentication tag and the expected tag to obtain an authentication result, wherein, the authentication result is a successful match, and the portion of the image is authenticated.

Aspect 2: The method of aspect 1, wherein the expected tag image is authenticated prior to loading the expected tag.

Aspect 3: The method of aspects 1 or 2, wherein the expected tag image further comprises a plurality of additional expected tags, and wherein each of the plurality of additional expected tags corresponds to a separate one of a plurality of images.

Aspect 4: The method of any of aspects 1-3, wherein, before providing the authentication indication to the hardware memory authenticator, the hardware memory authenticator is disactivated.

Aspect 5: The method any of aspects 1-4, further comprising discarding, after performing the comparison, the expected tag from the first memory region

Aspect 6: The method of any of aspects 1-5, further comprising performing a second comparison of a second authentication tag and a second expected tag for a second portion of the image to obtain a second authentication result, wherein the second authentication result is a failed match, and the second portion of the image is not authenticated.

Aspect 7: The method of any of aspects 1-6, further comprising: rebooting a sub-system of a computing device; and using, after the rebooting, a second expected tag from the expected tag image to authenticate an image corresponding to the sub-system.

Aspect 8: The method of any of aspects 1-7, wherein the expected tag image is a signed image.

Aspect 9: The method of any of aspects 1-8, wherein providing the authentication indication to the hardware memory authenticator comprises setting a bit associated with the hardware memory authenticator to a value that indicates that the hardware memory authenticator is to authenticate the image.

Aspect 10: The method of any of aspects 1-9, wherein, after the image is authenticated, the image is available to be executed on a computing device.

Aspect 11: An apparatus for image authentication for secure boot, the apparatus comprising: at least one memory; and at least one processor coupled to the at least one memory and configured to: obtain an expected tag image comprising an expected tag corresponding to an image to be loaded into memory; load, by a memory controller, the expected tag into a first memory region corresponding to a hardware memory authenticator; load, by the memory controller, the image into a second memory region; provide an authentication indication to the hardware memory authenticator, wherein the authentication indication triggers the hardware memory authenticator to authenticate the image; read a portion of the image from the second memory region; generate, at the hardware memory authenticator, an authentication tag corresponding to the portion of the image; and perform a comparison of the authentication tag and the expected tag to obtain an authentication result, wherein, the authentication result is a successful match, and the portion of the image is authenticated.

Aspect 12: The apparatus of aspect 11, wherein the expected tag image is authenticated prior to loading the expected tag.

Aspect 13: The apparatus of aspects 11 or 12, wherein the expected tag image further comprises a plurality of additional expected tags, and wherein each of the plurality of additional expected tags corresponds to a separate one of a plurality of images.

Aspect 14: The apparatus of any of aspects 11-13, wherein, before providing the authentication indication to the hardware memory authenticator, the hardware memory authenticator is disactivated.

Aspect 15: The apparatus of aspects 11-14, further comprising discarding, after performing the comparison, the expected tag from the first memory region.

Aspect 16: The apparatus of aspects 11-15, wherein the at least one processor is further configured to perform a second comparison of a second authentication tag and a second expected tag for a second portion of the image to obtain a second authentication result, wherein the second authentication result is a failed match, and the second portion of the image is not authenticated.

Aspect 17: The apparatus of aspects 11-16, wherein the at least one processor is further configured to: reboot a sub-system of a computing device; and use, after the reboot, a second expected tag from the expected tag image to authenticate an image corresponding to the sub-system.

Aspect 18: The apparatus of aspects 11-17, wherein the expected tag image is a signed image.

Aspect 19: The apparatus of aspects 11-18, wherein providing the authentication indication to the hardware memory authenticator comprises setting a bit associated with the hardware memory authenticator to a value that indicates that the hardware memory authenticator is to authenticate the image.

Aspect 20: The apparatus of aspects 11-19, wherein, after the image is authenticated, the image is available to be executed on a computing device.

Aspect 21: A non-transitory computer-readable medium having stored thereon instructions that, when executed by one or more processors, cause the one or more processors to: obtain an expected tag image comprising an expected tag corresponding to an image to be loaded into memory; load, by a memory controller, the expected tag into a first memory region corresponding to a hardware memory authenticator; load, by the memory controller, the image into a second memory region; provide an authentication indication to the hardware memory authenticator, wherein the authentication indication triggers the hardware memory authenticator to authenticate the image; read a portion of the image from the second memory region; generate, at the hardware memory authenticator, an authentication tag corresponding to the portion of the image; and perform a comparison of the authentication tag and the expected tag to obtain an authentication result, wherein, the authentication result is a successful match, and the portion of the image is authenticated.

Aspect 22: The non-transitory computer-readable medium of aspect 21, wherein the expected tag image is authenticated prior to loading the expected tag.

Aspect 23: The non-transitory computer-readable medium of aspects 21 or 22, wherein the expected tag image further comprises a plurality of additional expected tags, and wherein each of the plurality of additional expected tags corresponds to a separate one of a plurality of images.

Aspect 24: The non-transitory computer-readable medium of aspects 21-23, wherein, before providing the authentication indication to the hardware memory authenticator, the hardware memory authenticator is disactivated.

Aspect 25: The non-transitory computer-readable medium of aspects 21-24, The non-transitory computer-readable medium of claim 21, wherein the instructions further cause the one or processors to discard, after performing the comparison, the expected tag from the first memory region.

Aspect 26: The non-transitory computer-readable medium of aspects 21-25, wherein the instructions further cause the one or processors to perform a second comparison of a second authentication tag and a second expected tag for a second portion of the image to obtain a second authentication result, wherein the second authentication result is a failed match, and the second portion of the image is not authenticated

Aspect 27: The non-transitory computer-readable medium of aspects 21-26, wherein the instructions further cause the one or processors to: reboot a sub-system of a computing device; and using, after the reboot, a second expected tag from the expected tag image to authenticate an image corresponding to the sub-system.

Aspect 28: The non-transitory computer-readable medium of aspects 21-27, wherein the expected tag image is a signed image.

Aspect 29: The non-transitory computer-readable medium of aspects 21-28, wherein providing the authentication indication to the hardware memory authenticator comprises setting a bit associated with the hardware memory authenticator to a value that indicates that the hardware memory authenticator is to authenticate the image.

Aspect 30: The non-transitory computer-readable medium of aspects 21-29, wherein, after the image is authenticated, the image is available to be executed on a computing device.

What is claimed is:

1. A method for image authentication for secure boot, the method comprising:
obtaining an expected tag image comprising an expected tag corresponding to an image to be loaded into memory;
loading, by a memory controller, the expected tag into a first memory region corresponding to a hardware memory authenticator;
loading, by the memory controller, the image into a second memory region;
providing an authentication indication to the hardware memory authenticator, wherein the authentication indication triggers the hardware memory authenticator to authenticate the image;
reading a portion of the image from the second memory region;
generating, at the hardware memory authenticator, an authentication tag corresponding to the portion of the image; and
performing a comparison of the authentication tag and the expected tag to obtain an authentication result, wherein, the authentication result is a successful match, and the portion of the image is authenticated.

2. The method of claim 1, wherein the expected tag image is authenticated prior to loading the expected tag.

3. The method of claim 1, wherein the expected tag image further comprises a plurality of additional expected tags, and wherein each of the plurality of additional expected tags corresponds to a separate one of a plurality of images.

4. The method of claim 1, wherein, before providing the authentication indication to the hardware memory authenticator, the hardware memory authenticator is disactivated.

5. The method of claim 1, further comprising discarding, after performing the comparison, the expected tag from the first memory region.

6. The method of claim 1, further comprising performing a second comparison of a second authentication tag and a second expected tag for a second portion of the image to obtain a second authentication result, wherein the second authentication result is a failed match, and the second portion of the image is not authenticated.

7. The method of claim 1, further comprising:
rebooting a sub-system of a computing device; and
using, after the rebooting, a second expected tag from the expected tag image to authenticate an image corresponding to the sub-system.

8. The method of claim 1, wherein the expected tag image is a signed image.

9. The method of claim 1, wherein providing the authentication indication to the hardware memory authenticator comprises setting a bit associated with the hardware memory authenticator to a value that indicates that the hardware memory authenticator is to authenticate the image.

10. The method of claim 1, wherein, after the image is authenticated, the image is available to be executed on a computing device.

11. An apparatus for image authentication for secure boot, the apparatus comprising:
at least one memory; and
at least one processor coupled to the at least one memory and configured to:
obtain an expected tag image comprising an expected tag corresponding to an image to be loaded into memory;
load, by a memory controller, the expected tag into a first memory region corresponding to a hardware memory authenticator;
load, by the memory controller, the image into a second memory region;
provide an authentication indication to the hardware memory authenticator, wherein the authentication indication triggers the hardware memory authenticator to authenticate the image;
read a portion of the image from the second memory region;
generate, at the hardware memory authenticator, an authentication tag corresponding to the portion of the image; and
perform a comparison of the authentication tag and the expected tag to obtain an authentication result, wherein, the authentication result is a successful match, and the portion of the image is authenticated.

12. The apparatus of claim 11, wherein the expected tag image is authenticated prior to loading the expected tag.

13. The apparatus of claim 11, wherein the expected tag image further comprises a plurality of additional expected tags, and wherein each of the plurality of additional expected tags corresponds to a separate one of a plurality of images.

14. The apparatus of claim 11, wherein, before providing the authentication indication to the hardware memory authenticator, the hardware memory authenticator is disactivated.

15. The apparatus of claim 11, further comprising discarding, after performing the comparison, the expected tag from the first memory region.

16. The method of claim 1, wherein the at least one processor is further configured to perform a second comparison of a second authentication tag and a second expected tag for a second portion of the image to obtain a second authentication result, wherein the second authentication result is a failed match, and the second portion of the image is not authenticated.

17. The apparatus of claim 11, wherein the at least one processor is further configured to:
reboot a sub-system of a computing device; and
use, after the reboot, a second expected tag from the expected tag image to authenticate an image corresponding to the sub-system.

18. The apparatus of claim 11, wherein the expected tag image is a signed image.

19. The apparatus of claim 11, wherein providing the authentication indication to the hardware memory authenticator comprises setting a bit associated with the hardware memory authenticator to a value that indicates that the hardware memory authenticator is to authenticate the image.

20. The apparatus of claim 11, wherein, after the image is authenticated, the image is available to be executed on a computing device.

21. A non-transitory computer-readable medium having stored thereon instructions that, when executed by one or more processors, cause the one or more processors to:
obtain an expected tag image comprising an expected tag corresponding to an image to be loaded into memory;
load, by a memory controller, the expected tag into a first memory region corresponding to a hardware memory authenticator;
load, by the memory controller, the image into a second memory region;
provide an authentication indication to the hardware memory authenticator, wherein the authentication indication triggers the hardware memory authenticator to authenticate the image;
read a portion of the image from the second memory region;
generate, at the hardware memory authenticator, an authentication tag corresponding to the portion of the image; and
perform a comparison of the authentication tag and the expected tag to obtain an authentication result, wherein, the authentication result is a successful match, and the portion of the image is authenticated.

22. The non-transitory computer-readable medium of claim 21, wherein the expected tag image is authenticated prior to loading the expected tag.

23. The non-transitory computer-readable medium of claim 21, wherein the expected tag image further comprises a plurality of additional expected tags, and wherein each of the plurality of additional expected tags corresponds to a separate one of a plurality of images.

24. The non-transitory computer-readable medium of claim 21, wherein, before providing the authentication indication to the hardware memory authenticator, the hardware memory authenticator is disactivated.

25. The non-transitory computer-readable medium of claim 21, wherein the instructions further cause the one or processors to discard, after performing the comparison, the expected tag from the first memory region.

26. The non-transitory computer-readable medium of claim 21, wherein the instructions further cause the one or processors to perform a second comparison of a second authentication tag and a second expected tag for a second portion of the image to obtain a second authentication result, wherein the second authentication result is a failed match, and the second portion of the image is not authenticated.

27. The non-transitory computer-readable medium of claim 21, wherein the instructions further cause the one or processors to:
reboot a sub-system of a computing device; and
using, after the reboot, a second expected tag from the expected tag image to authenticate an image corresponding to the sub-system.

28. The method of claim 1, wherein the expected tag image is a signed image.

29. The non-transitory computer-readable medium of claim 21, wherein providing the authentication indication to the hardware memory authenticator comprises setting a bit associated with the hardware memory authenticator to a value that indicates that the hardware memory authenticator is to authenticate the image.

30. The non-transitory computer-readable medium of claim 21, wherein, after the image is authenticated, the image is available to be executed on a computing device.
